(19) United States
(12) Patent Application Publication
(10) Pub. No.: US 2026/0222698 A1
(43) Pub. Date: Jul. 30, 2026

(54) EVENT VISION SENSORS WITH DIGITAL EVENT DETECTION

(71) Applicant: OMNIVISION TECHNOLOGIES, INC., Santa Clara, CA (US)

(72) Inventors: Andreas Suess, San Jose, CA (US); Boyd Fowler, Sunnyvale, CA (US)

(21) Appl. No.: 19/037,248

(22) Filed: Jan. 26, 2025

(51) Int. Cl. H04N 25/47; H04N 25/616; H04N 25/772

(52) U.S. Cl. CPC H04N 25/47; H04N 25/616; H04N 25/772

(57) ABSTRACT

Event vision sensors with digital event detection (and associated systems, devices, and methods) are disclosed herein. In one embodiment, an image sensor includes an EVS pixel, an analog-to-digital converter (ADC), and event detection circuitry. The EVS pixel can include a photosensor, an integrating-type photo-detecting stage, and in-pixel sampling circuitry comprising a plurality of circuit branches that are each configured to perform correlated double sampling (CDS) operations to sample integrated irradiance levels. The ADC can be coupled to the in-pixel sampling circuitry and configured to convert the integrated irradiance levels into corresponding digital signals. The event detection circuitry can be coupled to the ADC and configured to generate event signals based at least in part on temporal contrast differences between the corresponding digital signals output by the ADC and a contrast threshold.

### TECHNICAL FIELD

This disclosure relates generally to image sensors. For example, several embodiments of the present technology are directed to event vision sensors and/or hybrid image sensors that employ EVS pixels and corresponding pixel-level or cluster-level analog-to-digital converters to facilitate digital event detection.

### BACKGROUND

Image sensors have become ubiquitous and are now widely used in digital cameras, cellular phones, security cameras, as well as medical, automobile, and other applications. As image sensors are integrated into a broader range of electronic devices, it is desirable to enhance their functionality, performance metrics, and the like in as many ways as possible (e.g., resolution, power consumption, dynamic range, etc.) through both device architecture design as well as image acquisition processing.

A typical image sensor operates in response to image light from an external scene being incident upon the image sensor. The image sensor includes an array of pixels having photosensitive elements (e.g., photodiodes) that absorb a portion of the incident image light and generate image charge upon absorption of the image light. The image charge photogenerated by the pixels may be measured as analog output image signals on column bitlines that vary as a function of the incident image light. In other words, the amount of image charge generated is proportional to the intensity of the image light, which can be read out as analog image signals from the column bitlines and converted to digital values to provide information that is representative of the external scene.

### BRIEF DESCRIPTION OF THE DRAWINGS

Non-limiting and non-exhaustive embodiments of the present technology are described below with reference to the following figures, in which like or similar reference numbers are used to refer to like or similar components throughout unless otherwise specified.

FIG. 1 is a partially schematic diagram of a stacked hybrid complementary metal oxide semiconductor (CMOS) image sensor (CIS) and event-based vision sensor (EVS) system, configured in accordance with various embodiments of the present technology.

FIG. 2 is a partially schematic circuit diagram of an EVS pixel configured in accordance with various embodiments of the present technology.

FIG. 3 is a partially schematic circuit diagram of an analog-to-digital converter and event detection circuitry, each configured in accordance with various embodiments of the present technology.

FIG. 4 is a partially schematic circuit diagram of another EVS pixel configured in accordance with various embodiments of the present technology.

Skilled artisans will appreciate that elements in the figures are illustrated for simplicity and clarity and are not necessarily drawn to scale. For example, the dimensions of some of the elements in the figures may be exaggerated relative to other elements to aid in understanding of various aspects of the present technology. In addition, common but well-understood elements or methods that are useful or necessary in a commercially feasible embodiment are often not depicted in the figures, or described in detail below, to avoid unnecessarily obscuring the description of various aspects of the present technology.

### DETAILED DESCRIPTION

The present technology is generally directed to event vision sensors and hybrid image sensors. For example, several embodiments of the present technology discussed in detail below relate to event vision sensor (EVS) pixels that employ integrating-type photo-detecting stages and in-pixel sampling circuitry in combination with analog-to-digital converts to perform digital event detection. As a specific example, several EVS pixels described in detail below include in-pixel sampling circuitry with two circuit branches: (a) a first circuit branch configured to perform a first correlated double sampling (CDS) operation to sample an integrated reference irradiance level, and (b) a second circuit branch configured to perform a second correlated double sampling (CDS) operation to sample a momentary integrated signal irradiance level. The in-pixel CDS operations are expected to reduce, minimize, and/or eliminate noise (e.g., fixed pattern noise, kTC noise, etc.). The integrated reference irradiance level and the momentary integrated signal irradiance level can be read out from the respective circuit branch of the in-pixel sampling circuitry and converted into corresponding digital signals by a pixel-level, cluster-level, or peripheral level analog-to-digital converter (ADC). In turn, event detection circuitry can (i) compute a difference between the digital signals, and (ii) compare the difference to a contrast threshold to generate event signals, performing all computations in the digital domain.

In the following description, specific details are set forth to provide a thorough understanding of aspects of the present technology. One skilled in the relevant art will recognize, however, that the systems, devices, and techniques described herein can be practiced without one or more of the specific details set forth herein, or with other methods, components, materials, etc.

Reference throughout this specification to an “example” or an “embodiment” means that a particular feature, structure, or characteristic described in connection with the example or embodiment is included in at least one example or embodiment of the present technology. Thus, use of the phrases “for example,” “as an example,” or “an embodiment” herein are not necessarily all referring to the same example or embodiment and are not necessarily limited to the specific example or embodiment discussed. Furthermore, features, structures, or characteristics of the present technology described herein may be combined in any suitable manner to provide further examples or embodiments of the present technology.

Spatially relative terms (e.g., “beneath,” “below,” “over,” “under,” “above,” “upper,” “top,” “bottom,” “left,” “right,” “center,” “middle,” and the like) may be used herein for ease of description to describe one element's or feature's relationship relative to one or more other elements or features as illustrated in the figures. It will be understood that the spatially relative terms are intended to encompass different orientations of a device or system in use or operation, in addition to the orientation depicted in the figures. For example, if a device or system illustrated in the figures is rotated, turned, or flipped about a horizontal axis, elements or features described as “below” or “beneath” or “under” one or more other elements or features may then be oriented “above” the one or more other elements or features. Thus, the exemplary terms “below” and “under” are non-limiting and can encompass both an orientation of above and below. The device or system may additionally, or alternatively, be otherwise oriented (e.g., rotated ninety degrees about a vertical axis, or at other orientations) than illustrated in the figures, and the spatially relative descriptors used herein are interpreted accordingly. In addition, it will also be understood that when an element is referred to as being “between” two other elements, it can be the only element between the two other elements, or one or more intervening elements may also be present.

Temporal relative terms such as “simultaneously,” “substantially simultaneously,” or “at the same time” are used herein to describe simultaneous performance or operation occurrence in a near instantaneous manner that takes into account necessary delays in signal transmission and/or processing, such as circuitry processing time, signal propagation time, computing time, or the like associated with circuit components. Thus, unless otherwise specified, “simultaneously,” “substantially simultaneously,” or “at the same time” as used herein may refer to events or operations that occur at the exact same time or within one second or less of each other after taking into account signal transmission and/or processing.

It will be understood that, although the terms first, second, third, etc., may be used in the disclosure and claims to describe various elements, these elements should not be limited by these terms and should not be used to determine the process sequence or formation order of associated elements. Unless otherwise indicated, these terms are merely used to distinguish one element from another element. Thus, a first element discussed below could be termed a second element without departing from the teachings of the disclosed embodiments. As another example, an element can be termed a “third element” to distinguish the element (e.g., for antecedent-basis purposes) from another element termed a “first element,” and without requiring the presence of a second element.

It is appreciated that the term “semiconductor material” recited throughout the disclosure may correspond to a part of or an entirety of a semiconductor wafer (e.g., a silicon wafer). In some embodiments, the semiconductor material may include or otherwise formed of silicon, a silicon germanium alloy, germanium, a silicon carbide alloy, an indium gallium arsenide alloy, any other alloys formed of III-V group compounds, combinations thereof, one or more epitaxial layers of the aforementioned materials, or a bulk substrate thereof. More specifically, semiconductor material may correspond to any semiconductor material or combination of materials that may be doped or otherwise configured to facilitate the formation of an integrated circuit (e.g., forming individual circuitry components such as source/drain regions of transistors, memory elements, photodiodes, or the like). It is appreciated that the term “photodiode” may correspond to a doped region disposed within the semiconductor material configured to photogenerate image charge(s) (e.g., one or more electrons or holes) in response to incident light. For example, photodiode may correspond to an n-doped region disposed within a p-type semiconductor material or an n-doped region surrounded by a p-type well disposed within the semiconductor material.

Throughout this specification, several terms of art are used. These terms are to take on their ordinary meaning in the art from which they come, unless specifically defined herein or the context of their use would clearly suggest otherwise. It should be noted that element names and symbols may be used interchangeably through this document (e.g., Si vs. silicon); however, both have identical meaning.

### A. Overview

An active pixel sensor employs an array of pixels that are used to capture intensity images/video of an external scene. More specifically, the pixels are used to obtain CIS information (e.g., intensity information) corresponding to light from the external scene that is incident on the pixels. CIS information obtained during an integration period is read out at the end of the integration period and used to generate a corresponding intensity image of the external scene.

In comparison, event vision sensors (e.g., event driven sensors or dynamic vision sensors) employ EVS pixels that are usable to obtain non-CIS information (e.g., contrast information, intensity changes, event data) corresponding to light from an external scene that is incident on those EVS pixels. Many event vision sensors read out an EVS pixel and/or convert a corresponding pixel signal into a digital signal only when the EVS pixel detects a change (e.g., an event) in the external scene. In other words, in most event vision sensors, EVS pixels that do not detect a change in the external scene are not read out and/or pixel signals corresponding to such EVS pixels are not converted into digital signals (thereby saving power). As a result, unlike active pixel sensors with synchronous integration times, these event vision sensors do not suffer from limited dynamic ranges and are able to accurately capture high-speed motion. Thus, these event visions sensors are often more robust than active pixel sensors in low lighting conditions and/or in highly dynamic scenes because they are not affected by under/over exposure or motion blur associated with a synchronous shutter. Stated another way, such event vision sensors can be used to provide ultra-high frame rates and to accurately capture high-speed motions.

Hybrid image sensors employ an array of pixels that includes a combination of (i) active (CIS) pixels usable to obtain CIS information corresponding to light from an external scene and (ii) EVS pixels usable to obtain non-CIS information corresponding to light from the external scene. Such hybrid image sensors are therefore able to simultaneously capture (a) intensity images/video of an external scene and (b) events occurring within the external scene.

An EVS pixel is commonly configured such that its output is used to yield specific values when log intensity of light incident on a photosensor of the pixel exceeds predefined thresholds. More specifically, an EVS pixel is often configured such that its output yields a +1 value when log intensity increases by an amount greater than a first predefined threshold, indicating that an UP event (e.g., light changing from darker to brighter and greater than the first predefined threshold) has been detected within an external scene. In addition, the EVS pixel is often configured such that its output yields a −1 value when log intensity decreases by an amount greater than a second predefined threshold, indicating that a DOWN event (e.g., light changing from brighter to darker and greater than the second predefined threshold) has been detected within the external scene. The output of the EVS pixel can be used to yield no value (e.g., a value equivalent to zero (0)) when changes in log intensity observed by the EVS pixel do not exceed the first or second predefined thresholds, indicating that neither an UP event nor a DOWN event have been detected in the external scene.

Such EVS pixels typically include per-pixel circuitry that receives photocurrent as input and communicates events with row/column peripheral readout circuitry. In particular, such EVS pixels typically employ an analog front-end circuit for detection of events from photocurrent changes. Use of an analog front-end circuit, however, is associated with several drawbacks. For example, analog front-end circuits continuously consume DC power. As another example, some dynamic behavior of the analog front-end circuits can be signal dependent, making the dynamic behavior susceptible to problems associated with slewing from source follower transistors, kick-back from reset operations, etc. As still another example, scalability of analog front-end circuits is limited by fixed pattern noise (FPN) requirements, including considerations for amplifier sizing and capacitance ratios.

To address these concerns, the present technology is generally directed to event vision sensors and hybrid imaging sensors with digital event detection. For example, several embodiments disclosed herein are directed to event vision sensors and/or hybrid image sensors that employ EVS pixels having integrating-type front-end circuits. The integrating-type front-end circuits are each configured to synchronously produce analog signals indicative of non-CIS information (e.g., contrast information, intensity changes, event data), also referred to herein as EVS information, corresponding to light from an external scene that is incident on a photosensor of the respective EVS pixel. Each integrating-type front-end circuit includes or is coupled to an analog-to-digital converter (ADC) that is configured to convert analog signals produced using the integrating-type front-end circuit into corresponding digital signals.

As a specific example, an EVS pixel of the present technology can include an integrating-type photo-detecting stage coupled to in-pixel sampling circuitry. The in-pixel sampling circuitry can include a first circuit branch and a second circuit branch. The first circuit branch can be selectively coupled to an output of the integrating-type photo-detecting stage, such as via a first switch. When coupled to the output of the integrating-type photo-detecting stage, the first circuit branch can be configured to perform a first correlated double sampling (CDS) operation to sample an integrated reference irradiance level. Similarly, the second circuit branch of the in-pixel sampling circuitry can be (i) coupled to the output of the integrating-type photo-detecting stage, and (ii) configured to perform a second CDS operation to sample an integrated signal irradiance level. The in-pixel CDS operations are expected to reduce, minimize, and/or eliminate noise (e.g., fixed pattern noise, kTC noise, etc.).

To perform CDS operations, the first circuit branch and/or the second circuit branch can each include a difference circuit. In some embodiments, the difference circuit of the first circuit branch and/or the difference circuit of the second circuit branch can be a passive difference circuit. For example, the difference circuit can include a first capacitor, a second capacitor, and a switch that are each coupled to a common node. The common node can be (a) coupled to the output of the integrating-type photo-detecting stage via the first capacitor, (b) coupled to ground via the second capacitor, and (c) selectively coupled to a power supply voltage via the switch.

In other embodiments, the difference circuit of the first circuit branch and/or the difference circuit of the second circuit branch can be an active difference circuit. For example, the difference circuit can include a first common node and a second common node. The difference circuit can further include a first capacitor, a second capacitor, a switch, and an amplifier. The first common node can be coupled to the output of the integrating-type photo-detecting stage via the first capacitor. In addition, the second capacitor, the switch, and the amplifier can each be (a) coupled between the first common node and the second common node and (b) arranged in parallel with one another.

The in-pixel sampling circuit can be configured to selectively output analog signals to an analog-to-digital converter (ADC). For example, the first circuit branch of the in-pixel sampling circuit can output (e.g., via a source follower transistor) a first analog signal corresponding to an integrated reference irradiance level sampled by the first circuit branch. In addition, the second circuit branch of the in-pixel sampling circuit can output (e.g., via a source follower transistor) a second analog signal corresponding to a momentary integrated signal irradiance level sampled by the second circuit branch. Analog signals ouput from the in-pixel sampling circuit can be fed into the ADC and converted into corresponding digital signals. In turn, an event detection circuit can compute digital difference signals, each representing a difference between (i) a digital representation of an analog momentary integrated signal irradiance level and (ii) a digital representation of a corresponding analog integrated reference irradiance level. In turn, the event detection circuit can compare the digital difference signals to a contrast threshold to generate event signals, performing all computations in the digital domain.

When a digital difference signal is greater than (or equal to) the contrast threshold, an event signal can be asserted, indicating that the EVS pixel has detected an event in an external scene monitored by the EVS pixel. When an event is detected, the first circuit branch of the in-pixel sampling circuit can be coupled to the output of the integrating-type photo-detecting stage (e.g., via a switch) to sample a new integrated reference irradiance level. On the other hand, when a digital difference signal is less than (or equal to) the contrast threshold, the event signal can be de-asserted (or remain de-asserted), indicating that the EVS pixel has not detected an event in the external scene. As a result, the EVS pixel can maintain the current integrated reference irradiance level sampled by the first circuit branch, and can continue to produce analog momentary integrated signal irradiance levels for (a) conversion into the digital signal and (b) comparison to the digital representation of the current integrated reference irradiance level to produce additional digital difference signals for comparison to the contrast threshold to generate additional event signals. Thus, event vision sensors, hybrid imaging sensors, and/or EVS pixels configured in accordance with various embodiments of the present technology are configured to fully or entirely perform CDS operations, difference computations, and event detection in the digital domain.

In some embodiments, the ADC used to convert analog samples into corresponding digital signals can be pixel-level ADC (e.g., as opposed to a column-level ADC). For example, the ADC can be positioned within (e.g., on a same die as) the EVS pixel, and/or the ADC can be dedicated to (e.g., correspond only to) a single/independent/unique EVS pixel. In other embodiments, the ADC can be a cluster-level ADC (e.g., as opposed to a column-level ADC). For example, the ADC can be shared by a group of two or more EVS pixels (e.g., of different rows and/or different columns).

Use (i) of a pixel-level or cluster-level ADC to provide digital samples and (ii) of an event detection circuit to compute differences and handle threshold comparisons entirely in the digital domain, are expected to offer several advantages. For example, when latency requirements are low, part of a front-end circuit (e.g., the ADC) for one or more EVS pixels of the present technology can be powered down to reduce power consumption and/or conserve power. As another example, assuming that a small form factor ADC technology (e.g., ramp converters) is used, use of integrating-type front-end circuits with pixel-level or cluster-level ADCs is expected to improve scalability and help overcome latency bottlenecks. Furthermore, because EVS pixels configured in accordance with various embodiments of the present technology employ integrating-type front-end circuits with pixel-level or cluster-level ADCs, latency is expected to be determined by the exposure time and is no longer expected to be signal dependent. Moreover, use of correlated doubling sampling (CDS) techniques is expected to reduce, minimize, and/or eliminate fixed pattern noise and/or kTC noise from samples of integrated irradiance levels.

### B. Selected Embodiments of Event Vision Sensors with Digital Event Detection, and Associated Systems, Devices, and Methods

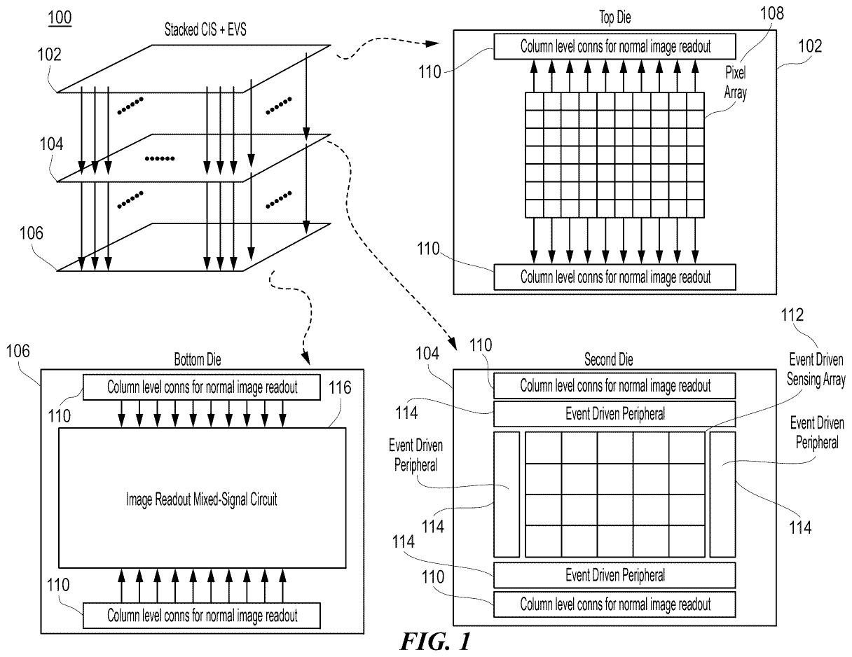

FIG. 1 is a partially schematic diagram of a stacked complementary metal oxide semiconductor (CMOS) image sensor (CIS) with an event-based vision sensor (EVS) system 100 (“the stacked system 100”), configured in accordance with various embodiments of the present technology. As shown, the stacked system 100 includes a first die 102, a second die 104, and a third die 106 that are stacked and coupled together in a stacked chip scheme. In some embodiments, the first die 102, the second die 104, and the third die 106 are semiconductor dies that include a suitable semiconductor material (e.g., silicon). In the illustrated embodiment, the first die 102 (also referred to herein as the “top die”) includes a pixel array 108. The third die 106 (also referred to herein as the “bottom die”) includes an image readout circuit 116 (also referred to herein as “image readout mixed-signal circuitry”). The image readout circuit 116 can be coupled to the pixel array 108 of the top die 102 through column level connections for normal image readout 110 (e.g., for intensity or luminance signal readout). In some embodiments, the column level connections for normal image readout 110 are implemented from column bitlines of the pixel array 108 with through silicon vias (TSVs) that extend between the top die 102 and the bottom die 106, and that are routed through the second die 104.

In some embodiments, the pixel array 108 is a two-dimensional (2D) array including a plurality of pixel cells (also referred to as “pixels” or as “pixel circuits”) that each includes at least one photosensor (e.g., at least one photodiode) exposed to incident light. As shown in the illustrated embodiment, the pixels are arranged into rows and columns. Pixels of the pixel array 108 can be operated at least partially as CIS pixels and/or at least partially as EVS pixels. When operated at least partially as CIS pixels, photosensors of the pixels can be used to acquire image data of an external scene (e.g., a person, place, object, etc., within the external scene) which can then be used to render images and/or video of the external scene. For example, each pixel, when at least partially operated in a CIS mode, can include one or more photosensors configured to photogenerate image charge in response to the incident light. After each pixel that is at least partially operated in a CIS mode has acquired its image charge, the corresponding analog image charge data can be read out by the image readout circuit 116 in the bottom die 106 through the column bit lines. In some embodiments, the image charge from each row of the pixel array 108 may be read out in parallel through column bit lines by the image readout circuit 116.

The image readout circuit 116 in the bottom die 106 can include amplifiers, analog to digital converter (ADC) circuitry, associated analog support circuitry, associated digital support circuitry, etc., for normal image readout and processing. In some embodiments, the image readout circuit 116 may also include event driven readout circuitry, which is described in greater detail below. In operation, the photogenerated analog image charge signals are read out from the pixel cells of pixel array 108, amplified, and converted to digital values in the image readout circuit 116. In some embodiments, image readout circuit 116 may read out a row of image data at a time. In other examples, the image readout circuit 116 may read out the image data using a variety of other techniques (not illustrated), such as a serial readout or a full parallel readout of all pixels simultaneously. The image data may be stored or even manipulated by applying post image effects (e.g., crop, rotate, remove red eye, adjust brightness, adjust contrast, and the like).

In the illustrated embodiment, the second die 104 (also referred to herein as the “middle die”) includes an event driven sensing array 112 that is coupled to the pixel array 108 in the top die 102. In some embodiments, the event driven sensing array 112 is coupled to the pixels of the pixel array 108 through hybrid bonds between the top die 102 and the middle die 104. The event driven sensing array 112 can include an array of event driven circuits. In some embodiments, each one of the event driven circuits in the event driven sensing array 112 is coupled to at least one of the plurality of pixels of the pixel array 108 through hybrid bonds between the top die 102 and the middle die 104 to synchronously detect events that occur in light that is incident upon the pixel array 108 in accordance with the teachings of the present disclosure.

In some embodiments, corresponding event detection signals are generated by the event driven circuits (e.g., integrating-type photo-detecting stages, in-pixel sampling circuitry, analog-to-digital converters, and/or event detection circuits) in the event driven sensing array 112. The event detection signals can be received and processed by event driven peripheral circuitry 114 (e.g., event detection circuitry) that, in some embodiments, is arranged around the periphery of the event driven sensing array 112 in the middle die 104 (as is shown in FIG. 1) or is positioned in the bottom die 106. The embodiment illustrated in FIG. 1 also illustrates column level connections for normal image readout 110 that are routed through the middle die 104 between the top die 102 and the bottom die 106.

Although discussed above in the context of hybrid image sensors, EVS pixels of the present technology can alternatively be employed in event vision sensors that omit CIS pixels. In these embodiments, circuitry of the EVS pixels can be distributed across one or more dies. For example, photosensors, all or a subset of integrating-type photo-detecting stages, all or a subset of in-pixel sampling circuitry, all or a subset of ADCs, all or a subset of event detection circuitry, and/or all or a subset of reset circuitry can be co-located on a same die. Alternatively, photosensors can be positioned on a first (top) die; all or a subset of integrating-type photo-detecting stages of the EVS pixels can be positioned on the first die and/or on a second (bottom or middle) die; all or a subset of in-pixel sampling circuitry can be position on the first die and/or on a second (bottom or middle die); all or a subset of analog digital converters can be positioned on the first die, the second die, and/or a third (bottom) die; all or a subset of event detection circuitry can be positioned on the second die and/or the third die; and/or all or a subset of reset circuitry can be positioned on the first die, the second die, and/or the third die. When distributed across multiple dies, the various circuitry can be connected using interconnect structures, such as TSVs, vias, hybrid bonds (e.g., pixel-level hybrid bonds), etc.

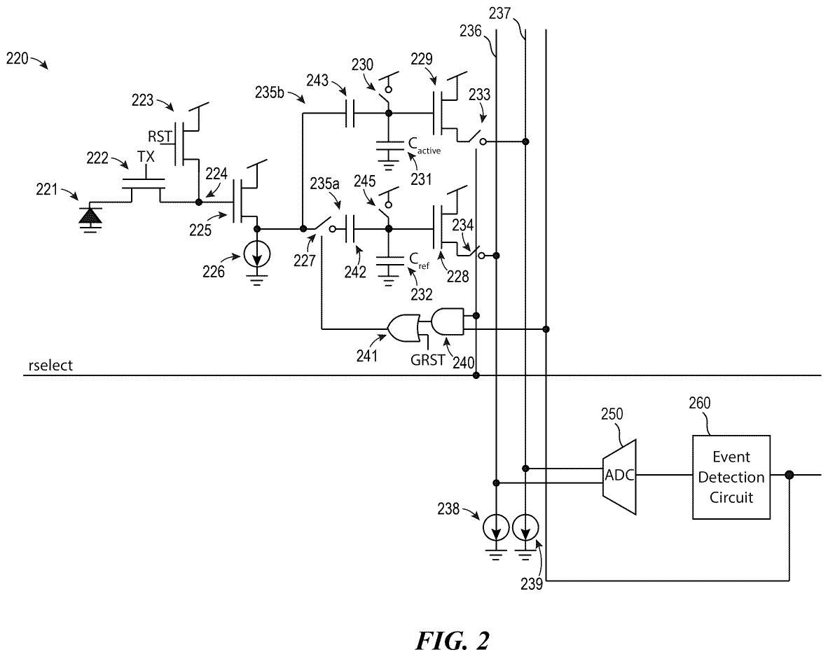

FIG. 2 is a partially schematic circuit diagram of an event vision sensor (EVS) pixel 220 configured in accordance with various embodiments of the present technology. The EVS pixel 220 can be an example of one of the pixels of the pixel array 108 of FIG. 1 or of other EVS pixels configured in accordance with various embodiments of the present technology. As shown, the EVS pixel 220 includes a photosensor 221, an integrating-type photo-detecting stage, in-pixel sampling circuitry, an analog-to-digital converter 250 (“ADC 250”), an event detection circuit 260, and reset circuitry. In the illustrated embodiment, the reset circuitry includes an AND logic gate 240 and an OR logic gate 241.

In some embodiments, the photosensor 221 includes a photodiode or another suitable type of photosensor. As a specific example, the photosensor 221 includes a pinned photodiode. In operation, the photosensor 221 is configured to photogenerate image charge based at least in part on light incident on the photosensor 221 from an external scene.

The integrating-type photo-detecting stage includes a transfer transistor 222 selectively coupling (and thereby selectively transferring image charge photogenerated by) the photosensor 221 to a floating diffusion 224 based at least in part on a transfer signal TX. The integrating-type photo-detecting stage further includes a reset transistor 223 and a first source follower transistor 225. The reset transistor 223 is configured to selectively couple the floating diffusion 224 to a power supply voltage (and thereby reset a voltage at the floating diffusion 224) based at least in part on a reset signal RST. When the reset transistor 223 and the transfer transistor 222 are simultaneously in an activated state, the photosensor 221 can additionally be coupled to the power supply voltage via the transfer transistor 222 and the reset transistor 223.

The first source follower transistor 225 is coupled between the power supply voltage and ground, and includes a gate coupled to the floating diffusion 224. More specifically, the first source follower transistor 225 is coupled between the power supply and a first current source 226, and the first current source 226 is coupled between the first source follower transistor 225 and ground. The first source follower transistor 225 is configured to produce an analog voltage signal at its source based at least in part on a voltage at the floating diffusion 224 that is applied to the gate of the first source follower transistor 225.

The in-pixel sampling circuitry includes a first circuit branch 235a and a second circuit branch 235b. Referring first to the first circuit branch 235a, the first circuit branch 235a can be selectively coupled to the source of the first source follower transistor 225 (e.g., an output of the integrating-type photo-detecting stage) via a first switch 227. For example, when the first switch 227 is activated, the first circuit branch 235a can be AC-coupled to the output of the integrating-type photo-detecting stage.

As shown, the first circuit branch 235a includes a first capacitor 242, a second capacitor 232, a second switch 245, and a second source follower transistor 228. The first capacitor 242 includes a first terminal (or plate) and a second terminal (or plate). In some embodiments, the first terminal of the first capacitor 242 can be selectively coupled to the output of the integrating-type photo-detecting stage via the first switch 227, and the second terminal of the first capacitor 242 can be coupled to a first node, which may also be coupled to (i) the gate of the second source follower transistor 228, (ii) a first terminal (or plate) of the second capacitor 232, and (iii) the second switch 245. In other embodiments, the first switch 227 can be positioned on an opposite side of the first capacitor 242 from the position shown in FIG. 2. In these embodiments, the first terminal of the first capacitor 242 can be coupled to the output of the integrating-type photo-detecting stage, and the second terminal can be selectively coupled to the first node via the first switch 227.

In the illustrated embodiment, the second capacitor 232 includes (i) the first terminal coupled to the first node and (ii) a second terminal (or plate) coupled to ground. In addition, the second switch 245 is configured to selectively couple the first node (and therefore the second terminal of the first capacitor 242, the first terminal of the second capacitor 232, and the gate of the second source follower transistor 228) to a power supply voltage or another reference voltage. In some embodiments, coupling the first node to the power supply voltage or another reference voltage may reset a voltage at the first node.

The second source follower transistor 228 includes the gate coupled to the first node, a drain coupled to the power supply voltage, and a source. As shown, the source of the second source follower transistor 228 can be selectively coupled to a first readout line 236 via a fifth switch 234. The fifth switch 234 can be controlled using a row select signal rselect. When the row select signal rselect is asserted, the source of the second source follower transistor 228 can be coupled to the first readout line 236 via the fifth switch 234.

In operation, when the first switch 227 is activated to couple the first circuit branch 235a to the output of the integrating-type photo-detecting stage, the first capacitor 242 and the second capacitor 232 may together function as a high pass filter. This high pass filter may be configured to filter out lower frequency components from the output of the integrating-type photo-detecting stage. Thus, the first circuit branch 235a may, when AC-coupled to the output of the integrating-type photo-detecting stage, ignore slow or gradual changes in the output of the integrating-type photo-detecting stage in response to incident light from an external scene. Instead, the first circuit branch 235a may detect quick or sudden changes that occur in the output of the integrating-type photo-detecting stage as a result of quick and sudden changes in photocurrent generated by the photosensor 221.

The first capacitor 242, the second capacitor 232, and the second switch 245 can further operate as a passive difference circuit that is configured to perform a first in-pixel CDS operation to sample an integrated reference irradiance level. For example, while the first switch 227 is activated, the second switch 245 may be activated to couple the first node to the power supply voltage (or another reference voltage) and reset the voltage at the first node to a first reset level. Total charge Q on the first capacitor 242 and the second capacitor 232 at time t₁ (corresponding to a timing when the second switch 245 is activated) can be modeled using Equation 1 below in which V_{ref} is the power supply voltage (or another reference voltage) coupled to the second switch 245, C₁ is the capacitance of the first capacitor 242, C₂ is the capacitance of the second capacitor 232, and Vᵢₙ is the voltage at the first terminal of the first capacitor 242 (shown coupled to the first switch 227 in FIG. 2):

$$Q = {C}_{1} * [ {V}_{in} ( {t}_{1} ) - {V}_{ref} ] - {C}_{2} * {V}_{ref} \qquad Equation 1$$

The second switch 245 may then be deactivated. Thereafter, at least while the first circuit branch 235a is coupled to the output of the integrating-type photo-detecting stage, the first circuit branch 235a can generate a voltage Vₒᵤₜ at the first node that is based at least in part on the first reset level and the voltage at the output of the integrating-type photo-detecting stage. More specifically, the voltage produced at the first node may change in proportion to a change of the voltage at the source of the first source follower transistor 225 relative to the time (e.g., t₁ in Equation 1 above) at which the second switch 245 was deactivated. In particular, total charge Q on the first capacitor 242 and the second capacitor 232 at time t (corresponding to a timing after the second switch 245 is deactivated and the first switch 227 is activated) can be modeled using Equation 2 below in which C₁ is the capacitance of the first capacitor 242, C₂ is the capacitance of the second capacitor 232, and Vᵢₙ is the voltage at the first terminal of the first capacitor 242:

$$Q = {C}_{1} * [ {V}_{in} ( t ) - {V}_{out} ( t ) ] - {C}_{2} * {V}_{out} ( t ) \qquad Equation 2$$

Thus, using Equations 1 and 2 above, the voltage Vₒᵤₜ at the first node at time t relative to the reference voltage V_{ref} at time t₁ can be provided by Equation 3 below:

$${V}_{out} ( t ) = {V}_{ref} + [ {V}_{in} ( {t}_{1} ) - {V}_{in} ( t ) ] * ( {C}_{1} / ( {C}_{1} + {C}_{2} ) ) \qquad Equation 3$$

In other words, the passive difference circuit formed by the first capacitor 242, the second capacitor 232, and the second switch 245 of the first circuit branch 235a can perform a first in-pixel CDS operation, which can factor out noise (e.g., fixed pattern noise (FPN), kTC noise, etc.) from the voltage signal produced at the first node. The voltage produced at the first node may therefore correspond to a sample of an integrated reference irradiance level, which becomes fixed when the first switch 227 is deactivated to uncouple the first circuit branch 235a from the output of the integrating-type photo-detecting stage.

As shown in Equation 3 above, the voltage produced at the first node may appear with a relative gain or attenuation that may be dependent upon the capacitance (C₁) of the first capacitor 242 and the capacitance (C₂) of the second capacitor 232. For example, the voltage at the first node may appear with a relative gain or attenuation given by the capacitance C₁ divided by the sum of the capacitance C₁ and the capacitance C₂ (e.g., C₁/(C₁+C₂)) due to the capacitive voltage divider formed by the first capacitor 242 and the second capacitor 232.

The voltage produced at the first node may be applied to the gate of the second source follower transistor 228 such that the second source follower transistor 228 produces a corresponding analog signal (also referred to herein as an analog integrated reference irradiance level) at its source. The analog integrated reference irradiance level produced by the second source follower transistor 228 may be output onto the first readout line 236 via the fifth switch 234 when the row select signal rselect is asserted.

Because the first capacitor 242, the second capacitor 232, and the second switch 245 are passive components, the difference circuit formed by these components of the first circuit branch 235a may consume a small amount of power in comparison to solutions employing active circuit components. As such, the EVS pixel 220 can be suitable for use in low power, battery-operated, and/or always-on event driven sensors.

Referring now to the second circuit branch 235b of the in-pixel sampling circuitry, the second circuit branch 235b is coupled to the output of the integrating-type photo-detecting stage (e.g., the source of the first source follower transistor 225). For example, the second circuit branch 235b can be AC-coupled to the output of the integrating-type photo-detecting stage.

As shown in FIG. 2, the second circuit branch 235b can include a third capacitor 243, a fourth capacitor 231, a third switch 230, and a third source follower transistor 229. The third capacitor 243 can have a first terminal (or plate) and a second terminal (or plate). The first terminal of the third capacitor 243 can be coupled to the source of the first source follower transistor 225. The second terminal of the third capacitor 243 can be coupled to a second node, which can also be coupled to (i) a gate of the third source follower transistor 229, (ii) a first terminal (or plate) of the fourth capacitor 231, and (iii) the third switch 230.

The fourth capacitor 231 can have (i) the first terminal coupled to the second node and (ii) a second terminal (or plate) coupled to ground. The third switch 230 can selectively couple the second node (and therefore the second terminal of the third capacitor 243, the first terminal of the fourth capacitor 231, and the gate of the third source follower transistor 229) to a power supply voltage. In some cases, coupling the second node to the power supply voltage can reset a voltage at the second node.

The third source follower transistor 229 can include the gate coupled to the second node. The third source follower transistor 229 can further include a drain coupled to the power supply voltage. The third source follower transistor 229 can include a source selectively coupled to a second readout line 237 via a fourth switch 233. The fourth switch 233 can be controlled using the row select signal rselect. In some cases, when the row select signal rselect is asserted, the source of the third source follower transistor 229 can be coupled to the second readout line 237 via the fourth switch 233. The third source follower transistor 229 can be configured to produce an analog signal at its source that corresponds to voltage applied to its gate at the second node.

In operation, the third capacitor 243 and the fourth capacitor 231 can together function as a high pass filter that can be configured to filter out lower frequency components from the output of the integrating-type photo-detecting stage. Thus, the second circuit branch 235b can ignore slow or gradual changes in the output of the integrating-type photo-detecting stage in response to incident light from an external scene. Instead, the second circuit branch 235b can detect quick or sudden changes that occur in the output of the integrating-type photo-detecting stage as a result of quick and sudden changes in photocurrent generated by the photosensor 221.

The third capacitor 243, the fourth capacitor 231, and the third switch 230 can form and operate as a passive difference circuit. For example, the third switch 230 can be activated to couple the second node to the power supply voltage (or another reference voltage) and reset the voltage at the second node to a second reset level. The third switch 230 can then be deactivated. Based at least in part on the second reset level and the voltage at the output of the integrating-type photo-detecting stage, the second circuit branch 235b can generate a voltage at the second node.

The passive difference circuit formed by the third capacitor 243, the fourth capacitor 231 and the third switch 230 can operate in a manner generally similar to the passive difference circuit formed by the first capacitor 242, the second capacitor 232 and the second switch 245 of the first circuit branch 235a described above. Thus, the voltage produced at the second node of the passive difference circuit formed by the third capacitor 243, the fourth capacitor 231 and the third switch 230 can change in proportion to a change of the voltage at the source of the first source follower transistor 225 relative to the time at which the third switch 230 was deactivated. In other words, the second circuit branch 235b can perform a second in-pixel CDS operation, which can factor out (e.g., reduce, minimize, eliminate) noise (e.g., fixed pattern noise (FPN), kTC noise, etc.) from the voltage signal produced at the second node. An instantaneous voltage produced at the second node can therefore correspond to a sample of a momentary integrated signal irradiance level.

Consistent with the discussion of Equations 1-3 above, the voltage produced at the second node can appear with a relative gain or attenuation that can be dependent upon the capacitance (C₃) of the third capacitor 243 and the capacitance (C₄) of the fourth capacitor 231. For example, the voltage at the second node can appear with a relative gain or attenuation given by the capacitance C₃ divided by the sum of the capacitance C₃ and the capacitance C₄ (e.g., C₃/(C₃+C₄)) due to the capacitive voltage divider formed by the third capacitor 243 and the fourth capacitor 231.

The voltage produced at the second node can be applied to the gate of the third source follower transistor 229 such that the third source follower transistor 229 can produce a corresponding analog signal (also referred to herein as an analog momentary integrated signal irradiance level) at its source. The analog momentary integrated signal irradiance level produced by the third source follower transistor 229 can be output onto the second readout line 237 via the fourth switch 233 when the row select signal rselect is asserted.

Because the third capacitor 243, the fourth capacitor 231, and the third switch 230 are passive components, the difference circuit formed by these components of the second circuit branch 235b may consume a small amount of power in comparison to solutions employing active circuit components. As such, the EVS pixel 220 can be suitable for use in low power, battery-operated, and/or always-on event driven sensors.

In the illustrated embodiment, the first and second readout lines 236, 237 feed into the ADC 250. As discussed in greater detail below, the ADC 250 is configured to convert analog signals received from the sources of the second and third source follower transistors 228, 229 into corresponding digital signals. In some embodiments, conversion of analog signals output onto the first and second readout lines 236, 237 into digital signals by the ADC 250 can be initiated based at least in part assertion of the row select signal rselect that is used to activate the fourth switch 233 and the fifth switch 234. Initiation of the conversion based on the row select signal rselect is expected to reduce power consumption and/or reserve power, as described in greater detail below. Digital signals output by the ADC 250 are then input into the event detection circuit 260.

The ADC 250 may be implemented as a pixel-level ADC, a cluster-level ADC, or a peripheral-level ADC. When implemented as a pixel-level ADC, the ADC 250 can be dedicated to a single (e.g., only one) pixel, such as the EVS pixel 220 illustrated in FIG. 2. Thus, in some such implementations, each EVS pixel employed by a corresponding event vision sensor can include its own unique instance of the ADC 250. It is expected that use of pixel-level ADCs will enable fast, asynchronous readout.

When implemented as a cluster-level ADC, the ADC 250 can be shared amongst a group (or cluster) of EVS pixels (e.g., including the EVS pixel 220 of FIG. 2). The group of EVS pixels can include two or more EVS pixels arranged in different rows of a corresponding event driven sensing array. Additionally, or alternatively, the group of EVS pixels can include two or more EVS pixels arranged in different columns of a corresponding event driven sensing array. In some embodiments, when using cluster-level ADC, EVS pixels can be read out row-by-row during a preset evaluation period, with readout of each row being allocated a same amount of time. In some such embodiments, EVS pixel rows that do not include any EVS pixels that detected events can be skipped during the readout process. It is expected that use of pixel-level ADCs and/or cluster-level ADCs will facilitate achieving desired latency goals of approximately 100 ns or less line-time.

When implemented as a peripheral-level ADC, the ADC 250 can be shared amongst all or large subsets of EVS pixels of a corresponding event driven sensing array. It is expected that use of a peripheral-level ADC may reduce or minimize EVS pixel footprint but at a cost of increased latency.

In some embodiments, the ADC 250 can be configured with desired capabilities. For example, the ADC 250 can have a signal-to-noise ratio (SNR) rating of approximately 76 dB and/or a 13-bit resolution in 100 μs or less. Such a resolution is expected to handle a large dynamic range of input signals. In other embodiments, a smaller ADC resolution can be used for smaller dynamic ranges of input signals (e.g., that are achieved using exposure control techniques in combination with cluster-level or pixel-level ADCs). In these and still other embodiments, the ADC 250 can be a compressive or nonlinear ADC. Additionally, or alternatively, the ADC 250 can be configured as a ramp converter. In these and other embodiments, the ADC 250 can be selectively powered down (e.g., during exposure/integration periods, such as for the photosensor 221), such as to reduce power consumption and/or conserve power (e.g., in situations in which latency requirements are low). For example, the ADC 350 can be powered up and/or powered down (e.g., selectively powered on and/or selectively powered off) based at least in part on a row select signal (e.g., the row select signal rselect that is used to selectively activate the fourth switch 233 and the fifth switch 234, as discussed above with reference to FIG. 2). As a specific example, the ADC 350 can be powered down when the row select signal is not asserted (or is de-asserted), and/or the ADC 350 can be powered up when the row select signal is asserted. Stated another way, the ADC 350 can be powered down when the fourth switch 233 and the fifth switch 234 are deactivated or turned OFF, and/or the ADC 350 can be powered up when the fourth switch 233 and the third switch 234 are activated.

As discussed in greater detail below, the event detection circuit 260 can be configured to (i) compute a digital difference between corresponding digital signals output from the ADC 250 and (ii) compare the digital difference to a contrast threshold to generate event signals indicative of whether the EVS pixel 220 has detected an event in an external scene monitored by the EVS pixel 220. When the digital difference is greater than (or equal to) the contrast threshold, an event signal output from the event detection circuit 260 can be asserted. On the other hand, when the digital difference is less than (or equal to) the contrast threshold, the event signal output from the event detection circuit 260 can be de-asserted (or remain de-asserted).

In the illustrated embodiment, the output of the event detection circuit 260 is connected to an input of the AND logic gate 240. The AND logic gate 240 may be further configured to receive the row select signal rselect. Thus, an output of the AND logic gate 240 can be asserted when the output of the event detection circuit 260 is asserted (indicating that the EVS pixel 220 has detected an event) while the row select signal rselect is also asserted.

The output of the AND logic gate 240 can be coupled to an input of the OR logic gate 241. Another input of the OR logic gate 241 may receive a global reset signal GRST. Thus, an output of the OR logic gate 241 can be asserted when the output of the AND logic gate 240 is asserted or when the global reset signal GRST is asserted.

The output of the OR logic gate 241 can be fed back to the in-pixel sampling circuitry of the EVS pixel 220 to control the first switch 227. For example, when the output of the OR logic gate 241 is asserted, the first circuit branch 235a of the in-pixel sampling circuitry can be coupled to the output of the integrating-type photo-detecting stage such that the first circuit branch 235a can (using the passive difference circuit formed by the first capacitor 242, the second capacitor 232, and the second switch 245) generate and sample a new integrated reference irradiance level at the first node.

On the other hand, when a digital difference output by the difference detector circuit of the event detection circuit 260 is less than (or equal to) the contrast threshold, the output of the event detection circuit 260 can be de-asserted (or remain de-asserted). As a result, the output of the AND logic gate 240 may remain de-asserted. In this case, the integrated reference irradiance level sampled by the first circuit branch 235a may be maintained until the EVS pixel 220 detects an event or until the global reset signal GRST is asserted.

Although not shown in the illustrated embodiment, the EVS pixel 220 can include several components in addition to the components illustrated in FIG. 2. For example, the EVS pixel 220 can be configured as (and therefore include corresponding circuit components for) a high dynamic range (HDR) pixel. Additionally, or alternatively, the EVS pixel 220 can be configured as (and therefore include corresponding circuit components for) a dual conversion gain (DGC) pixel. In these and still other embodiments, the EVS pixel 220 can be configured as (and therefore include corresponding circuit components for) a lateral-overflow-integration-capacitor-type (“LOFIC-type”) pixel. The DCG pixel and/or the LOFIC-type pixel can be achieved by selectively extending (or used to selectively extend) the charge capacity of the floating diffusion 224.

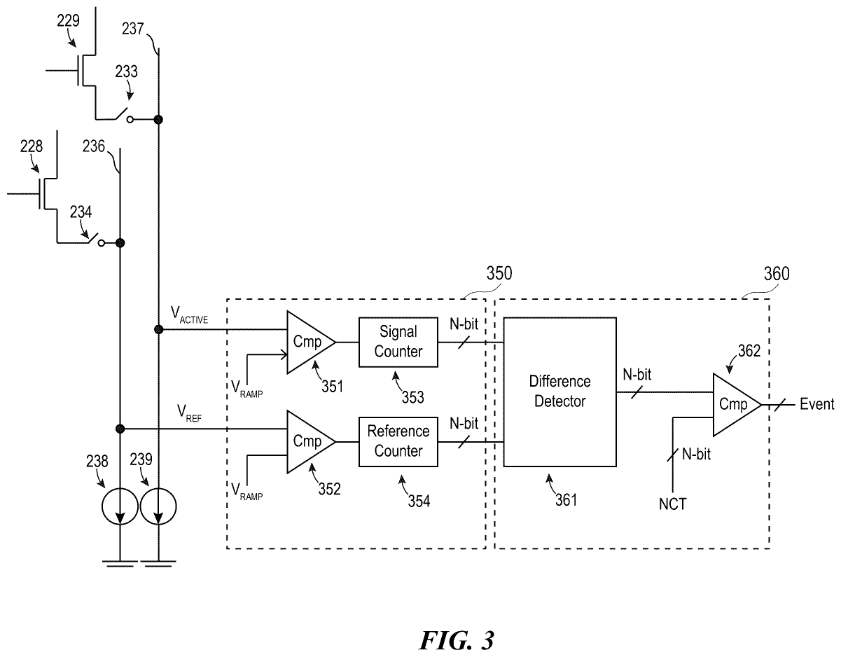

FIG. 3 is a partially schematic circuit diagram of an analog-to-digital converter 350 (“ADC 350”) and an event detection circuit 360, each configured in accordance with various embodiments of the present technology. The ADC 350 can be an example of the ADC 250 of FIG. 2, and the event detection circuit 360 can be an example of the event detection circuit 260 of FIG. 2. Indeed, the ADC 350 and the event detection circuit 360 are illustrated in FIG. 3 as being coupled to the second source follower transistor 228, the third source follower transistor 229, the fourth switch 233, the fifth switch 234, the first readout line 236, the second readout line 237, the second current source 238, and the third current source 239 that were each discussed above with reference to FIG. 2. Alternatively, the ADC 350 and/or the event detection circuit 360 can be an example of other ADCs and/or other event detection circuitry, respectively, configured in accordance with various embodiments of the present technology.

Referring first to the ADC 350, the ADC 350 is illustrated with a first comparator 351, a second comparator 352, a first counter 353 (also referred to herein as a “signal counter” or a “first digital counter”), and a second counter 354 (also referred to herein as a “reference counter” or a “second digital counter”). The first comparator 351 includes a first input coupled to the second readout line 237 and configured to receive, via the fourth switch 233, an analog signal produced at the source of the third source follower transistor 229. The first comparator 351 further includes a second input configured to receive a ramp signal VRAMP. Similarly, the second comparator 352 includes a first input coupled to the first readout line 236 and configured to receive, via the fifth switch 234, an analog signal produced at the source of the second source follower transistor 228. The second comparator 352 further includes a second input configured to receive the ramp signal VRAMP.

In some embodiments, the ADC 350 can be configured as a ramp converter. For example, the first and second comparators 351, 352 can each be configured to compare a respective analog signal received at its first input to the analog ramp signal VRAMP fed into its second input. The analog ramp signal VRAMP fed into its second input can be based on a count maintained and incremented by the first counter 353 and/or the second counter 354. More specifically, when an analog signal is read onto the second readout line 237 via the fourth switch 233, the first counter 353 can begin incrementing a count up from zero, which can be converted into the analog ramp signal VRAMP by a digital-to-analog converter (not shown). The analog ramp signal VRAMP is ramped as the count increases. When the analog ramp signal VRAMP is equal to or greater than the analog signal fed into the first input of the first comparator 351 via the second readout line 237, the output of the first comparator 351 flips and the first counter 353 stops counting. The digital output of the first counter 353 (e.g., an N-bit value) can be output and fed into a first input of the event detection circuit 360. In some embodiments, the digital output of the first counter 353 can be a digital representation of a momentary integrated signal irradiance level that corresponds to an analog momentary integrated signal irradiance level produced at the source of the third source follower transistor 229 and output onto the second readout line 237 via the fourth switch 233.

Similarly, when an analog signal is read onto the first readout line 236 via the fifth switch 234, the second counter 354 can begin incrementing a count up from zero, which can be converted into the analog ramp signal VRAMP by a digital-to-analog converter (not shown). The analog ramp signal VRAMP is ramped as the count increases. When the analog ramp signal VRAMP is equal to or greater than the analog signal fed into the first input of the second comparator 352 via the first readout line 236, the output of the second comparator 352 flips and the second counter 354 stops counting. The digital output of the second counter 354 (e.g., an N-bit value) can be output and fed into a second input of the event detection circuit 360. In some embodiments, the digital output of the second counter 354 can be a digital representation of an integrated reference irradiance level that corresponds to an analog integrated reference irradiance level produced at the source of the second source follower transistor 228 and output onto the first readout line 236 via the fifth switch 234.

Referring now to the event detection circuit 360 of FIG. 3, the event detection circuit 360 includes a difference detector circuit 361 and a comparator 362. The difference detector circuit 361 includes a first input coupled to an output of the first counter 353 of the ADC 350 and a second input coupled to an output of the second counter 354 of the ADC 350. In operation, the difference detector is configured to (a) determine (e.g., compute) a difference between a first N-bit digital signal output from the first counter 353 and a second N-bit digital signal output from the second counter 354, and (b) feed the difference into a first input of the comparator 362. Thus, the difference detector circuit 361 can be a full adder, a full subtractor, a half subtractor, or another suitable type of circuit for computing a difference between the N-bit digital signals output from the ADC 350.

As shown, the comparator 362 receives, at its first input, the difference output by the difference detector circuit 361 as an N-bit digital signal. The comparator 362 further receives, at its second input, a nominal contrast threshold (NCT) as an N-bit digital signal. In some embodiments, the NCT corresponds to a (e.g., preset and/or programmable) contrast threshold value that provides a 50% fire probability for UP events and a 50% first probability for DOWN events. In the illustrated embodiment, the NCT is a unified NCT value that is used to detect both UP events and DOWN events. The comparator 362 is configured to (a) compare the difference received from the difference detector circuit 361 to the NCT and (b) assert an event signal Event output from the event detection circuit 360 when the difference is greater than or equal to the NCT. Assertion of the event signal Event can indicate an EVS pixel coupled to the event detection circuit 360 has detected an event in a monitored external scene. As discussed above, the asserted event signal Event can be passed to reset circuitry (e.g., an input of an AND logic gate) of the corresponding EVS pixel.

Although shown in FIG. 3 with a single (e.g., only one) instance of a difference detector circuit 361 and a single (e.g., only one) instance of a comparator 362, event detection circuits 360 of the present technology are not so limited. For example, in other embodiments, an event detection circuit can include multiple instances of difference detectors (similar to the difference detector circuit 361) and/or multiple instances of comparators (similar to the comparator 362). As a specific example, an event detection circuit of the present technology can include the difference detector circuit 361 and two instances of comparators (similar to the comparator 362 that each include an input coupled to the output of the difference detector circuit 361. Continuing with this example, the N-bit difference signal output from the difference detector circuit 361 can be fed into the first comparator for comparison to a first NCT signal, such as an NCT signal NCT_up used for detecting UP events (e.g., changes in contrast from darker to brighter). In addition, the N-bit difference signal output from the difference detector circuit 361 can be fed into the second comparator for comparison to a second NCT signal, such as an NCT signal NCT_dn used for detecting DOWN events (e.g., changes in contrast from brighter to darker). The first NCT signal and the second NCT signal can correspond to the same or different threshold values.

In some embodiments, the event detection circuit in the above example can be configured to output the output of the first comparator and the output of the second comparator as separate signals. This can enable downstream circuitry to determine whether the corresponding circuitry detected an UP event or a DOWN event. For example, when an output of the first comparator is asserted, this can indicate that the difference signal output from the difference detector circuit 361 was positive and/or had a magnitude greater than the first NCT signal (e.g., indicating detection of an UP event). As another example, when an output of the second comparator is asserted, this can indicate that the difference signal output from the difference detector circuit 361 was negative and/or had a magnitude greater than the second NCT signal (e.g., indicating detection of a DOWN event).

In these and other embodiments, the outputs of the first and second comparators can be combined, such as to control reset circuitry (e.g., the AND logic gate 240 and/or the OR logic gate 241 of FIG. 2) of the corresponding pixel. As a specific example, the event signal Event output from the event detection circuit can depend at least in part on the outputs of the first and second comparators. More specifically, the event signal Event output from the event detection circuit can be asserted when (a) the output of the first comparator is asserted (indicating that the difference signal output from the difference detector circuit 361 was positive and/or had a magnitude greater than the first NCT signal, which can indicate detection of an UP event) and/or (b) the output of the second comparator is asserted (indicating that the difference signal output from the difference detector circuit 361 was negative and/or had a magnitude greater than the second NCT signal, which can indicate detection of a DOWN event). In other words, the event signal Event can be asserted when either the output of the first comparator is asserted or the output of the second comparator is asserted. Thus, in some embodiments, the outputs of the first and second comparators can be fed into an OR logic gate (e.g., of the event detection circuit 360), and the output of the OR logic gate can be fed into an input of an AND logic gate (e.g., the AND logic gate 240 of FIG. 2) of reset circuitry of the corresponding pixel.

In some embodiments, the event detection circuit 360 can be configured as column-level circuitry. In other embodiments, the event detection circuit 360 can be configured as pixel-level circuitry (e.g., dedicated to a single or only one EVS pixel) or as cluster-level circuitry (e.g., dedicated to a group/cluster/subset of EVS pixels of a corresponding event driven sensing array.

Referring again to FIG. 2, a method of operating the EVS pixel 220 in combination with the ADC 250 and the event detection circuit 260 will now be described. The method may begin when either the global reset signal GRST is asserted or when both the row select signal rselect and the output of the event detection circuit 260 are asserted. Either of these conditions can cause the output of the OR logic gate 241 to be asserted, which may couple the first circuit branch 235a of the in-pixel sample circuitry to the output of the integrating-type photo-detecting stage (e.g., to the source of the first source follower transistor 225 via the first switch 227).

In some embodiments, the second switch 245 can be activated at a same time as or at a time occurring after the first switch 227 is activated. In other embodiments, the second switch 245 can be activated before (e.g., shortly before) the first switch 227 is activated. As discussed above, activating the second switch 245 can couple the first node to the power supply voltage and therefore reset a voltage at the first node to a first reset level. The second switch 245 can thereafter be deactivated to uncouple the first node from the power supply voltage.

In some embodiments, timing of when the second switch 245 is activated and/or deactivated can be synced with activation of the reset transistor 223 and/or the transfer transistor 222 of the integrating-type photo-detecting stage. For example, the reset transistor 223 and/or the transfer transistor 222 can be activated to reset a voltage at the floating diffusion 224 and/or the photosensor 221. In some embodiments, the second switch 245 can be activated during this time. Alternatively, the reset transistor 223 and/or the transfer transistor 222 can be deactivated at a timing before the second switch 245 is activated.

In some embodiments, the third switch 230 can be activated to couple the second node of the second circuit branch 235b to the power supply voltage and thereby reset a voltage at the second node to a second reset level. In some embodiments, the third switch 230 can be activated at a same timing as when the second switch 245 is activated. Additionally, or alternatively, the third switch 230 can be deactivated at a same timing as when the second switch 245 is deactivated.

The output of the OR logic gate 241 can remain asserted (and therefore the first capacitor 242, the second capacitor 232, and the gate of the second source follower transistor 228 can remain coupled to the source of the first source follower transistor 225 via the first switch 227) for a period delta_t. During the period delta_t, the first circuit branch 235a produces a voltage at the first node based at least in part on a voltage at the source of the first source follower transistor 225 and the first reset level. In particular, the voltage at the first node changes in proportion to a change of the voltage at the source of the first source follower transistor 225 relative to the time at which the second switch 245 was deactivated. Similarly, during the period delta_t, the second circuit branch 235b can produce a voltage at the second node based at least in part on the voltage at the source of the first source follower transistor 225 and the second reset level. In particular, the voltage at the second node changes in proportion to the change of the voltage at the source of the first source follower transistor 225 relative to the time at which the third switch 230 was deactivated.

After the period delta_t, the output of the OR logic gate 241 may be de-asserted, thereby opening the first switch 227 and decoupling the first capacitor 242, the second capacitor 232, and the gate of the second source follower transistor 228 from the source of the first source follower transistor 225. This may prevent further adjustments of the voltage at the first node of the first circuit branch 235a, thereby storing/sampling an integrated reference irradiance level at the first node.

The second source follower transistor 228 can, based at least in part on the integrated reference irradiance level at the first node, produce a corresponding analog integrated reference irradiance signal (also referred to herein as an “analog integrated reference irradiance level”) at the source of the second source follower transistor 228, which may be output onto the first readout line 236 via the fifth switch 234 when the row select signal rselect is asserted. At that time, the analog integrated reference irradiance signal may be fed into an input of the ADC 250, converted into a corresponding digital signal, and fed into a difference detector circuit of the event detection circuit 260.

During an exposure period t, event charge may be photogenerated by the photosensor 221 based on light from an external scene incident on the photosensor 221. The event charge can be transferred via the transfer transistor 222 to—and accumulated at—the floating diffusion 224 during the exposure period t. This may produce a corresponding analog voltage signal at the source of the first source follower transistor 225. As the corresponding analog voltage signal at the source of the first source follower transistor 225 changes during the exposure period t, the voltage at the second node of the second circuit branch 235b continues to change in proportion to the change of the corresponding analog voltage signal at the source of the first source follower transistor 225 relative to the time at which the third switch 230 was deactivated (e.g., relative to the second reset level).

At the end of the exposure period t, the transfer transistor 222 can be deactivated, thereby preventing further image charge from being transferred to the floating diffusion 224. As such, a voltage at the floating diffusion 224 remains relatively constant, meaning that a corresponding voltage at the source of the first source follower transistor 225 and at the second node remain relatively constant.

The voltage at the second node of the second circuit branch 235b is applied to the gate of the third source follower transistor 229. As such, the third source follower transistor 229 produces a corresponding analog momentary integrated signal irradiance signal (also referred to herein as an “analog momentary integrated signal irradiance level”) at the source of the third source follower transistor 229, which may be output onto the second readout line 237 via the fourth switch 233 when the row select signal rselect is asserted. At that time, the analog momentary integrated signal irradiance level may be fed into an input of the ADC 250, converted into a corresponding digital signal, and output to a difference detector circuit of the event detection circuit 260.

Using the corresponding digital signals output from the ADC 250, a difference detector circuit of the event detection circuit 260 computes and outputs a digital signal (also referred to herein as a “difference signal”) indicative of the difference between the corresponding digital signals. This comparison may be performed entirely in the digital domain.

Thereafter, the difference signal may be compared to a digital NCT signal corresponding to a nominal contrast threshold, which can be preset and/or programmable. In the event that the digital difference signal is less than (or equal to) the digital NCT signal, the output of the event detection circuit 260 may remain de-asserted, indicating that the EVS pixel 220 did not detect an event in the external scene during the exposure period t. In this case, the integrated reference irradiance level sampled onto the first node can be maintained on the first circuit branch 235a of the in-pixel sampling circuitry such that the second source follower transistor 228 continues to produce a same analog integrated reference irradiance signal at the source of the second source follower transistor 228, at least until the EVS pixel 220 detects an event or the global reset signal GRST is asserted to assert the output of the OR logic gate 241.

On the other hand, in the event that the digital difference signal output from the difference detector circuit of the event detection circuit 260 is greater than (or equal to) the digital NTC signal, the output of the event detection circuit 260 can be asserted, indicating that the EVS pixel 220 has detected an event during the exposure period t. The asserted output of the event detection circuit 260 may be fed back to the AND logic gate 240, thereby causing the output of the OR logic gate 241 to be asserted assuming that the row select signal rselect is also asserted. Assertion of the output of the OR logic gate 241 activates the first switch 227, thereby coupling the first capacitor 242, the second capacitor 232, the second switch 245, and the gate of the second source follower transistor 228 to the source of the first source follower transistor 225 (e.g., the output of the integrating-type photo-detecting stage). The first circuit branch 235a can thereafter be used to sample a new integrated reference irradiance level at the first node during a new period delta_t in accordance with the discussion above.

In this manner, the present technology facilitates computing event signals based on temporal contrast differences, with event detection (e.g., difference computations and/or threshold comparisons performed by the ADC 250 and the event detection circuit 260) handled entirely in the digital domain. The present technology also facilitates updating the integrated reference irradiance level when events are detected, thereby enabling EVS pixels to adapt to changing light conditions and detect subsequent events.

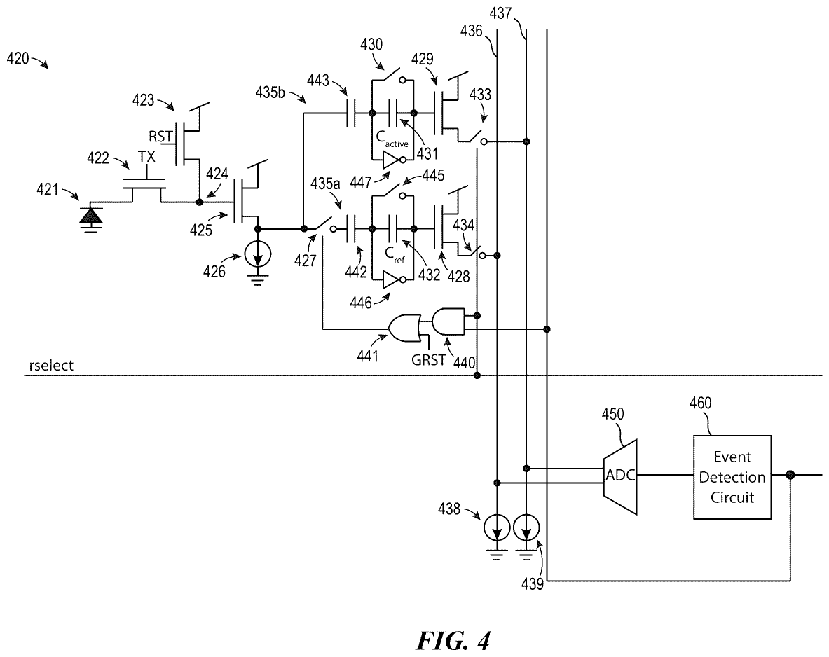

FIG. 4 is a partially schematic circuit diagram of another EVS pixel 420 configured in accordance with various embodiments of the present technology. The EVS pixel 420 can be an example of one of the pixels of the pixel array 108 of FIG. 1 or of other EVS pixels configured in accordance with various embodiments of the present technology. As shown, the EVS pixel 420 is generally similar to the EVS pixel 220 of FIG. 2. Thus, similar references numbers are uses across FIGS. 2 and 4 to denote identical or at least generally similar components, and a detailed description of such components is largely omitted here for the sake of brevity in light of the detailed description provided above with reference to FIG. 2 that similarly applies to the corresponding components illustrated in FIG. 4.

As shown in FIG. 4, the EVS pixel 420 includes a photosensor 421, an integrating-type photo-detecting stage, in-pixel sampling circuitry, an analog-to-digital converter 450 (“ADC 450”), an event detection circuit 460, and reset circuitry. In the illustrated embodiment, the reset circuitry includes an AND logic gate 440 and an OR logic gate 441. The integrating-type photo-detecting stage includes a transfer transistor 422 selectively coupling (and thereby selectively transferring image charge photogenerated by) the photosensor 421 to a floating diffusion 424 based at least in part on a transfer signal TX. The integrating-type photo-detecting stage further includes a reset transistor 423 and a first source follower transistor 425. The reset transistor 423 can be configured to selectively couple the floating diffusion 424 to a power supply voltage (and thereby reset a voltage at the floating diffusion 424) based at least in part on a reset signal RST. When the reset transistor 423 and the transfer transistor 422 are simultaneously in an activated state, the photosensor 421 can additionally be coupled to the power supply voltage via the transfer transistor 422 and the reset transistor 423.

The first source follower transistor 425 can be coupled between the power supply voltage and ground, and can include a gate coupled to the floating diffusion 424. More specifically, the first source follower transistor 425 can be coupled between the power supply and a first current source 426, and the first current source 426 can be coupled between the first source follower transistor 425 and ground. The first source follower transistor 425 can be configured to produce an analog voltage signal at its source based at least in part on a voltage at the floating diffusion 424 that is applied to the gate of the first source follower transistor 425.

The in-pixel sampling circuitry includes a first circuit branch 435a and a second circuit branch 435b. Referring first to the first circuit branch 435a, the first circuit branch 435a can be selectively coupled to the source of the first source follower transistor 425 (e.g., an output of the integrating-type photo-detecting stage) via a first switch 427. For example, when the first switch 427 is activated, the first circuit branch 435a can be AC-coupled to the output of the integrating-type photo-detecting stage.

In contrast with the first circuit branch 235a of the in-pixel circuitry of the EVS pixel 220 of FIG. 2, the first circuit branch 435a of the EVS pixel 420 of FIG. 4 includes a first capacitor 442, a second capacitor 432, a second switch 445, a first amplifier 446, and a second source follower transistor 428. The first capacitor 442 can have a first terminal (or plate) and a second terminal (or plate). In some embodiments, the first terminal of the first capacitor 442 can be coupled to the first switch 427, and the second terminal of the first capacitor 442 can be coupled to a first node, which can also be coupled to (i) a first terminal (or plate) of the second capacitor 432, (ii) the second switch 445, and (iii) an input of the first amplifier 446. In other embodiments, the first switch 427 can be positioned on an opposite side of the first capacitor 442 from the position shown in FIG. 4. In these embodiments, the first terminal of the first capacitor 442 can be coupled to the output of the integrating-type photo-detecting stage, and the second terminal can be selectively coupled to the first node via the first switch 427.

The second capacitor 432, the first amplifier 446, and the second switch 445 can be arranged in parallel between the first capacitor 442 and a gate of the second source follower transistor 428 (e.g., between the first node and a second node). More specifically, the second capacitor 432 can have (i) the first terminal (or plate) coupled to the first node and (ii) a second terminal (or plate) coupled to the second node, which can also be coupled to (i) an opposite side of the second switch 445 from a side of the second switch 445 that is coupled to the first node, (ii) a gate of the second source follower transistor 428, and (iii) an output of the first amplifier 446.

The second switch 445 can selectively couple the first node to the second node. Activating the second switch 445 can short the first terminal and the second terminal of the second capacitor 432 together, thereby bringing the first and second terminals of the second capacitor 432 to a same potential. Activating the second switch 445 can also short the input and the output of the first amplifier 446 together, thereby auto-zeroing the first amplifier 446 and setting the voltage at the first node equal to the voltage at the second node at a mid-potential that can be dependent on characteristics of the amplifier. Auto-zeroing the first amplifier 446 can largely or entirely cancel offset variation in the first circuit branch 435a.

As discussed above, the first amplifier 446 can include (i) the input (e.g., an inverting input) coupled to the first node and (ii) the output coupled to the second node. In some embodiments, the first amplifier 446 can be an op-amp and/or can further include another input (not shown), such as a non-inverting input, that can be coupled to ground.

The first capacitor 442, the second capacitor 432, the first amplifier 446, and/or the second switch 445 can form a filter amplifier that, when selectively AC-coupled to the output of the integrating-type photo-detecting stage via the first switch 427, can be configured to generate a filtered and amplified signal in response to a voltage output by the integrating-type photo-detecting stage. More specifically, the filter amplifier can include a high pass filter that can be configured to filter out lower frequency components from the voltage received from the output of the integrating-type photo-detecting stage. Thus, slow or gradual changes in the voltage output by the integrating-type photo-detecting stage can be ignored, instead detecting quick or sudden changes in the voltage output by the integrating-type photo-detecting stage that occur as a result of quick or sudden changes in photocurrent generated by the photosensor 421 in response to the incident light.

The first capacitor 442, the second capacitor 432, the second switch 445, and the first amplifier 446 of the first circuit branch 435a can form an active difference detector circuit that includes signal amplification at its output. Including signal amplification at the output is expected to (a) decrease non-uniformity, non-linearity, and/or other challenges in properly setting an operating point for the EVS pixel 420 or in calibrating the EVS pixel 420, and/or (b) improve noise performance.

The second source follower transistor 428 can include (i) the gate coupled to the second node, (ii) a drain coupled to a power supply voltage, and (iii) a source selectively coupled to a first readout line 436 via a fifth switch 434. The fifth switch 434 can be controlled using a row select signal rselect. When the row select signal rselect is asserted, the source of the second source follower transistor 428 can be coupled to the first readout line 436 via the fifth switch 434. The second source follower transistor 428 can be configured to produce an analog signal at its source that corresponds to voltage applied to its gate at the second node.

In operation, when or after the first switch 427 is activated to AC-couple the first circuit branch 435a to the output of the integrating-type photo-detecting stage, the second switch 445 can be activated such that the input and the output of the first amplifier 446 are shorted and the first amplifier 446 is auto-zeroed. This can sample the voltage at the source of the first source follower transistor 425 as a first reset level. In some embodiments, the voltage at the source of the first source follower transistor 425 can correspond to a voltage at the floating diffusion 424 after the voltage at the floating diffusion and/or the photosensor 421 have been reset using the reset transistor 423 and/or the transfer transistor 422. After sampling the first reset level, the second switch 445 can be deactivated and feedback between the second node and the first node across the second capacitor 432 can hinder major voltage swings at the first node. Voltage at the second node can then track the voltage at the source of the first source follower transistor 425 in an amplified manner and relative to the first reset level.

The voltage at the second node can be a difference signal that represents an amplified difference voltage relative to the initial reset time (e.g., the time that the second switch 445 is deactivated). In other words, the first circuit branch 435a can perform a first CDS operation to generate an integrated reference irradiance level at the second node that can be sampled/stored to the first circuit branch 435a at the time that the first switch 427 is deactivated. The first CDS operation can factor out (e.g., reduce, minimize, eliminate) noise (e.g., fixed pattern noise (FPN), kTC noise, etc.).

The voltage produced at the second node can be applied to the gate of the second source follower transistor 428 such that the second source follower transistor 428 produces a corresponding analog signal (also referred to herein as an analog integrated reference irradiance level) at its source. The analog integrated reference irradiance level produced at the source of the second source follower transistor 428 can be output onto the first readout line 436 via the fifth switch 434 when the row select signal rselect is asserted.

Referring now to the second circuit branch 435b of the in-pixel sampling circuitry, the second circuit branch 435b can be AC-coupled to the output of the integrating-type photo-detecting stage (e.g., the source of the first source follower transistor 425). The second circuit branch 435b can include a third capacitor 443, a fourth capacitor 431, a third switch 430, a second amplifier 447, and a third source follower transistor 429. The third capacitor 443 can have a first terminal (or plate) and a second terminal (or plate). The first terminal of the third capacitor 443 can be coupled to the output of the integrating-type photo-detecting stage (e.g., the source of the first source follower transistor 425). The second terminal of the third capacitor 443 can be coupled to a third node, which can also be coupled to (i) a first terminal (or plate) of the fourth capacitor 431, (ii) the third switch 430, and (iii) an input of the second amplifier 447.

The fourth capacitor 431, the second amplifier 447, and the third switch 430 can be arranged in parallel between the third capacitor 443 and a gate of the third source follower transistor 429 (e.g., between the third node and a fourth node). More specifically, the fourth capacitor 431 can have (i) the first terminal that is coupled to the third node and (ii) a second terminal (or plate) that is coupled to the fourth node, which can also be coupled to (i) an opposite side of the third switch 430 from a side of the third switch 430 that is coupled to the third node, (ii) a gate of the third source follower transistor 429, and (iii) an output of the second amplifier 447.

The third switch 430 can selectively couple the third node to the fourth node. Activating the third switch 430 can short the first terminal and the second terminal of the fourth capacitor 431 together, thereby bringing the first and second terminals of the fourth capacitor 431 to a same potential. Activating the third switch 430 can short the input and the output of the second amplifier 447 together, thereby auto-zeroing the second amplifier 447 and setting the voltage at the third node equal to the voltage at the fourth node at a mid-potential that can be dependent on characteristics of the amplifier. Auto-zeroing the second amplifier 447 can largely or entirely cancel offset variation in the second circuit branch 435b.

The second amplifier 447 can include (i) the input (e.g., an inverting input) that is coupled to the third node and (ii) the output that is coupled to the fourth node. In some cases, the second amplifier 447 can be an op-amp and/or can further include another input (not shown), such as a non-inverting input, that can be coupled to ground.

The third capacitor 443, the fourth capacitor 431, the second amplifier 447, and/or the third switch 430 can form a filter amplifier that can be configured to generate a filtered and amplified signal in response to a voltage output by the integrating-type photo-detecting stage. More specifically, the filter amplifier can include a high pass filter that can be configured to filter out lower frequency components from the voltage received from the output of the integrating-type photo-detecting stage. Thus, slow or gradual changes in the voltage output by the integrating-type photo-detecting stage can be ignored, instead detecting quick or sudden changes in the voltage output by the integrating-type photo-detecting stage that occur as a result of quick or sudden changes in photocurrent generated by the photosensor 421 in response to the incident light.

The third capacitor 443, the fourth capacitor 431, the third switch 430, and the second amplifier 447 of the second circuit branch 435b can form an active difference detector circuit that includes signal amplification at its output. Including signal amplification at the output is expected to (a) decrease non-uniformity, non-linearity, and/or other challenges in properly setting an operating point for the EVS pixel 420 or in calibrating the EVS pixel 420, and/or (b) improve noise performance.

The third source follower transistor 429 can include (i) the gate coupled to the fourth node, (ii) a drain coupled to the power supply voltage, and (iii) a source selectively coupled to a second readout line 437 via a fourth switch 433. The fourth switch 433 can be controlled using the row select signal rselect. When the row select signal rselect is asserted, the source of the third source follower transistor 429 can be coupled to the second readout line 437 via the fourth switch 433. The third source follower transistor 429 can be configured to produce an analog signal (also referred to herein as an analog momentary integrated signal irradiance level) at its source that corresponds to a voltage applied to its gate at the fourth node.

In operation, the third switch 430 can be activated such that the input and the output of the second amplifier 447 are shorted and the second amplifier 447 is auto-zeroed. This can sample the voltage at the source of the first source follower transistor 425 as a second reset level. In some embodiments, the voltage at the source of the first source follower transistor 425 can correspond to a voltage at the floating diffusion 424 after the voltage at the floating diffusion and/or the photosensor 421 have been reset using the reset transistor 423 and/or the transfer transistor 422. In these and other embodiments, the third switch 430 can be activated and/or deactivated at same timings as when the second switch 445 is activated and/or deactivated, respectively, for the first circuit branch 435a. After sampling the second reset level, the third switch 430 can be deactivated and feedback between the fourth node and the third node across the fourth capacitor 431 can hinder major voltage swings at the first node. Voltage at the fourth node can then track the voltage at the source of the first source follower transistor 425 in an amplified manner and relative to the second reset level.

The voltage at the fourth node can be a difference signal that represents an amplified difference voltage relative to the initial reset time (e.g., the time that the third switch 430 is deactivated). In other words, the second circuit branch 435b can perform a second CDS operation to sample an integrated signal irradiance level. The second CDS operation can factor out (e.g., reduce, minimize, eliminate) noise (e.g., fixed pattern noise (FPN), kTC noise, etc.).

The voltage produced at the fourth node can be applied to the gate of the third source follower transistor 429 such that the third source follower transistor 429 produces a corresponding analog signal (also referred to herein as an analog momentary integrated signal irradiance level) at its source. The analog momentary integrated signal irradiance level produced by the third source follower transistor 429 can be output onto the second readout line 437 via the fourth switch 433 when the row select signal rselect is asserted. Thus, the analog signal output onto the second readout line 437 via the fourth switch 433 can be referred to as an analog momentary integrated signal irradiance level corresponding to the voltage at the fourth node at the moment the row select signal rselect is asserted to activate the fourth switch 433.

The ADC 450, the event detection circuit 460, and the reset circuitry (e.g., the AND logic gate 440 and the OR logic gate 441) are generally similar to the ADC 250, the event detection circuit 460, and the reset circuitry (e.g., the AND logic gate 240 and the OR logic gate 441) of FIG. 2. Indeed, the ADC 350 and/or the event detection circuit 360 of FIG. 3 can be an example of the ADC 450 and/or the event detection circuit 460, respectively, of FIG. 4. For example, analog signals output by the second source follower transistor 428 and the third source follower transistor 429 can be fed into the ADC 450 and converted into corresponding digital signals in accordance with the discussion of FIGS. 2 and 3 above. The corresponding digital signals can be fed into the event detection circuit 460 and used to compute a difference signal (e.g., using a difference detector circuit similar to the difference detector circuit 361 of FIG. 3). The difference signal can be compared (e.g., using a comparator similar to the comparator 362 of FIG. 3) to a contrast threshold to generate event signals consistent with the discussion of FIGS. 2 and 3 above.

### C. Conclusion

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology as those skilled in the relevant art will recognize. For example, although steps are presented in a given order above, alternative embodiments may perform steps in a different order. Furthermore, the various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where context permits, singular or plural terms may also include the plural or singular term, respectively. In addition, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Moreover, as used herein, the phrases “based on,” “depends on,” “as a result of,” and “in response to” shall not be construed as a reference to a closed set of conditions. For example, an exemplary step that is described as “based on condition A” may be based on both condition A and condition B without departing from the scope of the present disclosure. In other words, as used herein, the phrase “based on” shall be construed in the same manner as the phrase “based at least in part on” or the phrase “based at least partially on.” Also, the terms “connect” and “couple” are used interchangeably herein and refer to both direct and indirect connections or couplings. For example, where the context permits, element A “connected” or “coupled” to element B can refer (i) to A directly “connected” or directly “coupled” to B and/or (ii) to A indirectly “connected” or indirectly “coupled” to B.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments. Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. An image sensor, comprising:
an event vision sensor (EVS) pixel including a photosensor, an integrating-type photo-detecting stage, and in-pixel sampling circuitry comprising a plurality of circuit branches that are each configured to perform correlated double sampling (CDS) operations to sample integrated irradiance levels;
an analog-to-digital converter (ADC) coupled to the in-pixel sampling circuitry and configured to convert the integrated irradiance levels into corresponding digital signals; and
event detection circuitry coupled to the ADC and configured to generate event signals based at least in part on (i) temporal contrast differences between the corresponding digital signals output by the ADC and (ii) a contrast threshold.

2. The image sensor of claim 1, wherein the plurality of circuit branches includes:
a first circuit branch configured, at least when coupled to an output of the integrating-type photo-detecting stage, to perform a first correlated double sampling operation to sample an integrated reference irradiance level; and
a second circuit branch coupled to the output of the integrating-type photo-detecting stage and configured to perform a second correlated double sampling operation to sample an integrated signal irradiance level.

3. The image sensor of claim 2, wherein the first circuit branch comprises a first capacitor, a second capacitor, and a switch coupled to a common node.

4. The image sensor of claim 3, wherein the switch is a first switch and the common node is a first common node, and wherein the second circuit branch comprises a third capacitor, a fourth capacitor, and a second switch coupled to a second common node.

5. The image sensor of claim 4, wherein the first circuit branch further comprises a first source follower transistor having a gate coupled to the first common node, and the second circuit branch further comprises a second source follower transistor having a gate coupled to the second common node.

6. The image sensor of claim 3, wherein:
the common node is a first common node;
the first circuit branch further comprises a second common node and an amplifier; and
the second capacitor, the switch, and the amplifier are coupled in parallel between the first common node and the second common node.

7. The image sensor of claim 6, wherein:
the switch is a first switch and the amplifier is a first amplifier;
the second circuit branch comprises a third capacitor, a fourth capacitor, a second switch, and a second amplifier coupled to a third common node; and
the fourth capacitor, the second switch, and the second amplifier are coupled in parallel between the third common node and a fourth common node.

8. The image sensor of claim 2, wherein:
the first circuit branch is selectively AC-coupled to the output of the integrating-type photo-detecting stage via a switch; and
the second circuit branch is AC-coupled to the output of the integrating-type photo-detecting stage.

9. The image sensor of claim 2, further comprising reset circuitry configured to cause the first circuit branch to perform a third correlated double sampling operation to sample a new integrated reference irradiance level when a temporal contrast difference between a pair of corresponding digital signals output by the ADC is greater than the contrast threshold.

10. The image sensor of claim 1, wherein the ADC is a pixel-level ADC dedicated to only the EVS pixel.

11. The image sensor of claim 1, wherein the ADC is a cluster-level ADC shared by a group of EVS pixels including the EVS pixel.

12. The image sensor of claim 1, wherein the photosensor comprises a pinned photodiode.

13. The image sensor of claim 1, wherein the event detection circuitry comprises:
a difference detector circuit configured to compute digital difference signals, each representing a difference between a pair of corresponding digital signals output by the ADC; and
a comparator configured to compare the digital difference signals to a digital representation of the contrast threshold to generate the event signals.

14. A method of operating an image sensor, the method comprising:
sampling, using a first circuit branch of in-pixel sampling circuitry of an event vision sensor (EVS) pixel, an integrated reference irradiance level using a first correlated double sampling operation performed on the first circuit branch;
sampling, using a second circuit branch of the in-pixel sampling circuitry, a momentary integrated signal irradiance level using a second correlated double sampling operation performed on the second circuit branch;
converting, using an analog-to-digital converter (ADC), the integrated reference irradiance level and the momentary integrated signal irradiance level into corresponding digital signals;
computing, using event detection circuitry, a digital difference signal based on the corresponding digital signals; and
comparing the digital difference signal to a contrast threshold to generate an event signal.

15. The method of claim 14, wherein sampling the integrated reference irradiance level comprises:
activating a first switch to couple the first circuit branch to an output of an integrating-type photo-detecting stage of the EVS pixel;
resetting a voltage at a first node of the first circuit branch to a first reset level; and
generating a voltage at the first node based at least in part on the first reset level and a voltage at the output of the integrating-type photo-detecting stage.

16. The method of claim 15, wherein sampling the momentary integrated signal irradiance level comprises:
resetting a voltage at a second node of the second circuit branch to a second reset level; and
generating a voltage at the second node based at least in part on the second reset level and the voltage at the output of the integrating-type photo-detecting stage.

17. The method of claim 14, further comprising:
outputting, using a first source follower transistor of the first circuit branch, a first analog signal based at least in part on the sampled integrated reference irradiance level; and
outputting, using a second source follower transistor of the second circuit branch, a second analog signal based at least in part on the momentary integrated signal irradiance level.

18. The method of claim 14, further comprising asserting the event signal when the digital difference signal is greater than or equal to the contrast threshold.

19. The method of claim 18, further comprising sampling, by the first circuit branch, a new integrated reference irradiance level in response to assertion of the event signal.

20. The method of claim 14, wherein converting the integrated reference irradiance level and the momentary integrated signal irradiance level into corresponding digital signals includes converting the integrated reference irradiance level and the momentary integrated signal irradiance level into corresponding digital signals using a pixel-level ADC dedicated to only the EVS pixel.

21. The method of claim 14, wherein converting the integrated reference irradiance level and the momentary integrated signal irradiance level into corresponding digital signals includes converting the integrated reference irradiance level and the momentary integrated signal irradiance level into corresponding digital signals using a cluster-level ADC shared by a group of EVS pixels including the EVS pixel.

22. An event vision sensor (EVS) pixel, comprising:
a photosensor;
an integrating-type photo-detecting stage coupled to the photosensor; and
in-pixel sampling circuitry coupled to an output of the integrating-type photo-detecting stage, the in-pixel sampling circuitry comprising:
a first circuit branch configured to perform a first correlated double sampling (CDS) operation to obtain an integrated reference irradiance level, and
a second circuit branch configured to perform a second CDS operation to obtain a momentary integrated signal irradiance level.

23. The EVS pixel of claim 22, wherein the integrating-type photo-detecting stage comprises:
a floating diffusion;
a reset transistor configured to selectively couple the floating diffusion to a power supply voltage; and
a source follower transistor having a gate coupled to the floating diffusion.

24. The EVS pixel of claim 23, wherein the integrating-type photo-detecting stage further comprises a transfer transistor configured to selectively couple the photosensor to the floating diffusion.

25. The EVS pixel of claim 22, wherein:
the first circuit branch comprises a first capacitor, a second capacitor, and a switch; and
the first capacitor, the second capacitor, and the switch are each coupled to a common node.

26. The EVS pixel of claim 25, wherein the first capacitor, the second capacitor, and the switch form a passive difference detector circuit that is configured to perform the first CDS operation.

27. The EVS pixel of claim 25, wherein:
the common node is a first common node;
the first circuit branch further comprises an amplifier; and
the second capacitor, the switch, and the amplifier are coupled in parallel between the first common node and a second common node.

28. The EVS pixel of claim 27, wherein the first capacitor, the second capacitor, the switch, and the amplifier form an active difference detector circuit configured to perform the first CDS operation.

29. The EVS pixel of claim 25, wherein:
the switch is a first switch and the common node is a first common node;
the second circuit branch comprises a third capacitor, a fourth capacitor, and a second switch; and
the third capacitor, the fourth capacitor, and the second switch are each coupled to a second common node.

30. The EVS pixel of claim 29, wherein the third capacitor, the fourth capacitor, and the second switch form a passive difference detector circuit that is configured to perform the second CDS operation.

31. The EVS pixel of claim 29, wherein:
the second circuit branch further comprises an amplifier; and
the fourth capacitor, the second switch, and the amplifier are coupled in parallel between the second common node and a third common node.

32. The EVS pixel of claim 31, wherein the third capacitor, the fourth capacitor, the second switch, and the amplifier form an active difference detector circuit configured to perform the second CDS operation.

33. The EVS pixel of claim 29, wherein the first circuit branch further comprises a first source follower transistor having a gate coupled to the first common node, and the second circuit branch further comprises a second source follower transistor having a gate coupled to the second common node.

34. The EVS pixel of claim 22, further comprising an analog-to-digital converter (ADC) configured to convert analog signals corresponding to integrated reference irradiance level and the momentary integrated signal irradiance level into respective digital signals.

35. The EVS pixel of claim 22, further comprising:
a switch configured to selectively couple the first circuit branch to the output of the integrating-type photo-detecting stage; and
reset circuitry configured to selectively activate the first switch based at least in part (i) a temporal contrast difference between a digital representation of the integrated reference irradiance level and a digital representation of the momentary integrated signal irradiance level and (ii) a contrast threshold, wherein activating the first switch enables the first circuit branch to sample a new integrated reference irradiance level using a third CDS operation.
